(19) United States
(12) Patent Application Publication
(10) Pub. No.: US 2005/0100377 A1
(43) Pub. Date: May 12, 2005

(54) Printer with auxiliary member for forming print gap, ribbon guide, ribbon cartridge, ribbon cassette, and printing method

(75) Inventors: Yoshito Honda, Fujisawa-shi (JP); Hiroshi Matsushita, Atsugi-shi (JP); Futoshi Sumida, Tokyo (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/973,600

(22) Filed: Oct. 26, 2004

(30) Foreign Application Priority Data
Oct. 28, 2003 (JP) 2003-367217

(51) Int. Cl. B41J 11/20

(52) U.S. Cl. 400/55

(57) ABSTRACT

This invention provides an auxiliary member forming print gap disposed in the lower end portion of a print head in a printer which comprises the print head for performing print by moving reciprocally in a primary scanning direction along a platen to an object of printing which is fed in a secondary scanning direction on a platen, a means for applying the resilient force to the platen or the print head so that their distance is smaller, and a gap roller for forming a predetermined print gap by running on the object of printing against the above resilient force during the reciprocal movement of the print head. The auxiliary member forming print gap comprises contact portions for expanding the gap between the platen and the print head and assisting in forming the predetermined print gap by contacting just before the gap roller contacts to the edge of the object of printing during the above reciprocal movement.

### FIELD AND BACKGROUND OF INVENTION

This invention relates to an auxiliary member forming print gap disposed at the top end of a print head to avoid poor printing quality caused by vibration at the time of contact of a gap roller and an object of the printing, as well as a ribbon guide using the auxiliary member forming print gap, a ribbon cartridge, a ribbon cassette, a printer and a printing method.

### SUMMARY OF THE INVENTION

Generally, a passbook printer of a movable platen type such as that shown in accompanying FIG. 4 has a feature of printing by keeping a print gap (head gap) between the top end of a print head 11 and a print face constant at any time, irrespective of the thickness of a passbook 12, by pressing the passbook 12 and a movable platen 13 supporting it downward D with a gap roller 15 at the top end of the print head 11.

In FIG. 4, reference numeral 22 designates a ribbon shield for shielding an ink ribbon from the print face, except for a portion where a print wire protrudes, so that the ink ribbon guided into the top end of the print head 11 may not contaminate the print face, and 24 designates a sheet disposed in a range where the gap roller 15 runs on the platen 13. The print head 11 is moved in a primary scanning direction that is the right and left direction in FIG. 4(a). Along with this movement, the gap roller 15 runs on the sheet 24 by pressing down the passbook 12 and the platen 13. The passbook 12 is fed in a secondary scanning direction perpendicular to the primary scanning direction to pass between the platen 13 and the sheet 24.

Similarly, a printer having a gap roller for forming an appropriate print gap has been well known in which the print head but not the platen is moved up or down in accordance with a level of print face at each running position of the gap roller (e.g., refer to patent document 1). In this printer, the gap roller is disposed at the upstream side of the print head to prevent the residual ink from being transferred via the gap roller to another part to contaminate the print face. Also, the corner portions of the ribbon cassette are rounded on both sides at the lower end, whereby when a print document of book type is printed, the paper is pressed down to suppress the floating of the edge of the document, so that the gap roller runs on the print document without trouble.

On the other hand, to detect a thick part of the object of printing and keep the print gap proper, a printer having two rollers each supported by a swing arm and provided on both sides of the print head has been offered (e.g., refer to patent document 2). In this printer, when the passbook is printed, the print is made by keeping the print head at constant height without contact of each roller with the print face while printing the ordinary portion, but when the print head approaches the thick part with seal impression, one roller contacts that part before the other to cause the print head to rise and keep the print gap proper.

Known prior art printers of this general type are shown in Japanese Published Unexamined Patent Application No. 11-179997 and Japanese Published Unexamined Patent Application No. 9-136467.

In a conventional passbook printer of a movable platen type, at the higher print speed, a problem occurs when the gap roller runs on the edge of the thick object of printing such as the passbook. That is, when the print head 11 is moved in a primary scanning direction B to print on the passbook 12, as shown in FIG. 4(a), if the passbook 12 is thick, the edge of the passbook 12 is subject to a large force downward D, and significantly vibrates, as shown in FIG. 4(b). Then, the gap roller 15 does not form the proper print gap, and the print wire does not reach the print face, whereby the print is not normally made, or thinner in some cases. This problem is not very remarkable when the print speed is about 33 inches per second (0.8382 [m/s]) that is commonly employed at the present time, but remarkable when the high speed print head is mounted to increase the running speed to 35 inches per second (0.889 [m/s]) or more.

As a solution to this problem, a method is considered in which the thickness of the object of printing is detected, and when it is thick, the print speed is made slower to suppress the vibration at the edge of the passbook 12. However, the performance of the high speed print head is not fully exhibited with this solution.

As another solution, a method for changing the force of a spring supporting the movable platen 13 and a method for making the platen of soft material are considered. However, if the force of the spring is weakened, the print pressure is decreased and the print is thinner. Conversely, if the force of the spring is stronger, the traces of the gap roller are colored thick, when the pressure sensitive paper is printed. Also, the paper can not be fed in a state where the print paper is carried between the gap roller and the platen. Also, if the platen is made of soft material, the machining accuracy of the platen is not secured, resulting in a risk that the accuracy of the gap between the platen and the print head is degraded. Therefore, there is a limitation in making the platen of the soft material.

The problem of vibration at the edge of the object of printing may also occur with the above-mentioned printer of the type in which the print head is moved up and down. In this printer, the lower end portions of the ribbon cassette are rounded to simply suppress the floating of the edge of the print document, but when the print document is thick, the gap roller exerts a strong impact on the edge of the print document.

On the other hand, in the printer having two rollers, since the rollers are kept away from the platen by the swing arms, and precede from a print wire portion, it is considered that the roller has less impact on the edge of the object of printing. However, the constitution around the print head is complicated. In the case where the vertical passbook is printed, the print head is lifted on one side when the rollers are moved from the thinner page of the open passbook to the thicker page, one roller being located on the thicker page, and the other roller being located on the thinner page, thereby the print gap increases on the thinner page near the fold in the center. At this time, it is required on the specification to securely print in a range of 5 [mm] or more from the fold in the center, but there is a risk that this specification is not met.

In view of the above-mentioned problems associated with the prior art, it is a purpose of this invention to keep print quality by avoiding vibration at the time of contact of the gap roller and the object of printing with a simple structure in the printer having a gap roller for forming an appropriate print gap.

In order to accomplish the above purpose, this invention provides an auxiliary member forming print gap disposed at the top end of a print head to assist in forming the predetermined print gap in the printer which comprises the print head for performing print by moving reciprocally in a primary scanning direction to an object of printing which is fed in a secondary scanning direction, a platen for supporting the object of printing below the print head, a means for applying the resilient force to the platen or the print head so that their distance is smaller, and a gap roller disposed at the print head to form a predetermined print gap by running on the object of printing on the platen against the above resilient force along with the movement of the print head. The auxiliary member comprises a contact portion for expanding the gap between the platen and the print head by contacting just before the gap roller contacts to the edge of the object of printing during the reciprocal movement of the print head.

Herein, the object of printing means various kinds of printing paper or passbook. The primary scanning direction means the direction where the print head is moved to perform printing. The secondary scanning direction means the direction perpendicular to the primary scanning direction where the object of printing is fed by a predetermined distance so that the print position by the print head is changed successively. In this specification, downward means the direction of the arrow D in FIG. 1. Accordingly, “below” in “below the print head” means the side of the object of printing to the print head. The print gap means the gap between the print face of the object of printing and the print head at the time of printing. The print head means the dot-impact type, ink-jet type or thermal transfer type printer. The resilient force means the force tending to return to the original position when a displacement occurs. The means for applying the resilient force includes various springs such as a leaf spring and a coil spring, an elastic body such as rubber, and various kinds of actuator. The gap roller is not limited to the ordinary cylindrical type, but may be spherical if the object of printing permits.

In this constitution, in printing on a predetermined portion of the object of printing on the platen, the print head is moved from one side of the primary scanning direction to the other. The gap roller is moved along with the print head, and exerts a pressure on the platen and the object of printing, while running on the edge of the object of printing on the way, so that a predetermined print gap is formed and kept constant on the print face of the object of printing. At this time, in the case where the moving speed of the print head is considerably fast, and the object of printing is considerably thick, the gap roller imparts a strong impact on the edge of the object of printing in running on it, so that the print face is greatly vibrated and left away from the gap roller to form an improper gap, possibly causing a risk for the poor print quality.

However, with this invention, the contact portion contacts just before the gap roller contacts to the edge of the object of printing and expands the gap between platen and print head. Therefore, when the gap roller contacts to the edge of the object of printing, the gap roller has reduced or little impact on the edge. Thereby, in the case where the moving speed of the print head is considerably fast, and the object of printing is considerably thick, the gap roller closely contacts to the print face near the edge of the object of printing at once, forming a proper print gap to perform clear printing.

In a preferred embodiment of the invention, the contact portion has a contact face contacting to the edge of the object of printing at an acute angle with a print face to cause a force expanding the gap between platen and print head, a bottom point of the contact face being higher than a lower end of the gap roller.

In this case, the contact portion may have a first contact face and a second contact face, the first contact face contacts to the edge of the object of printing before the second contact face, with the bottom point being higher. In this case, the gap between platen and print head is expanded at two stages with the contact between the edge of the object of printing and the first contact face as well as the second contact face.

Also, in this case, a recess adaptable to a bulge in a central folding part may be provided between the bottom point of the first contact face and the second contact face, when the object of printing is a vertical passbook. In this way, when the central folded part is bulged, it is possible to prevent the poor print quality from occurring near the folded part.

Usually, two contact portions are provided to correspond to the reciprocal movement of the print head. When the print head is dot-impact type, the contact portion contacts to the edge of the object of printing via a ribbon shield.

A ribbon guide of the invention has the auxiliary member forming print gap according to any one of the above forms, which is provided inside the ribbon shield. Also, a ribbon cartridge of the invention has the ribbon guide. Also, a ribbon cassette of the invention has the auxiliary member forming print gap according to any one of the above forms, which is provided inside the ribbon shield.

This invention provides the printer comprising the print head for performing print by moving reciprocally in a primary scanning direction to the object of printing which is fed in a secondary scanning direction, the platen for supporting the object of printing below the print head, the means for applying the resilient force to the platen or the print head so that their distance is smaller, the gap roller disposed at the print head to form a predetermined print gap by running on the object of printing on the platen against the above resilient force along with the movement of the print head, and the auxiliary member forming print gap according to any one of the above forms.

In this case, when the print head is dot-impact type, a sheet may be provided in a range where the gap roller runs on the platen. Then, the running of the gap roller is made on the sheet, and the object of printing is fed in the secondary scanning direction, passing between the platen and the sheet. In this case, when a pressure-sensitive form is printed, the running of the gap roller is prevented from being transferred between each form. Also, even when the gap roller is running on the sheet on the object of printing, the object of printing can be fed in the secondary scanning direction to make the print speed higher.

This invention provides a printing method comprising the process that the print head prints by moving reciprocally along the platen in a primary scanning direction to the object of printing which is fed onto the platen in a secondary scanning direction, the process by the means for applying the resilient force to the platen or the print head so that their distance is smaller, the process that the gap roller disposed at the print head forms a predetermined print gap by running on the object of printing on the platen against the above resilient force along with the movement of the print head, and the process that the contact portion of the auxiliary member forming print gap according to any one of the above forms expands the gap between the platen and the print head by contacting just before the gap roller contacts to the edge of the object of printing during the reciprocal movement of the print head.

With this invention, during the reciprocal movement of the print head, the contact portion contacts just before the gap roller contacts to the edge of the object of printing to expand the gap between platen and print head, thereby avoiding poor print quality by vibration at the time of contact of the gap roller and the edge of the object of printing.

### BRIEF DESCRIPTION OF DRAWINGS

Some of the purposes of the invention having been stated, others will appear as the description proceeds, when taken in connection with the accompanying drawings, in which:

FIG. 1 is a front view and a side view showing a principal portion of a passbook printer according to one embodiment of the present invention;

FIG. 2 is a front view and a side view showing the essence of a print head portion of the printer as shown in FIG. 1;

FIG. 3 is a view showing the constitution of a contact portion in the printer as shown in FIG. 1;

FIG. 4 is a view showing the problems associated with the prior art;

FIG. 5 is a view showing the movement of printing on the vertical passbook by the printer as shown in FIG. 1;

FIG. 6 is a view showing a ribbon cassette according to another embodiment of the invention; and

FIG. 7 is a view showing the open vertical passbook as seen from the above and a cross-sectional view taken along the line A-A.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

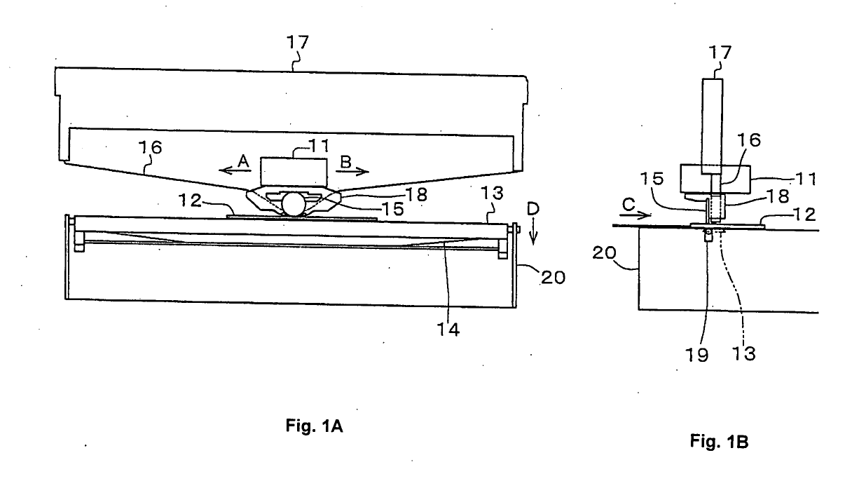

Referring now more particularly to FIGS. 1(a) and 1(b), what is there shown are a front view and a side view showing a principal portion of a passbook printer according to one embodiment of the present invention. This printer comprises a print head 11 of dot impact type running in the primary scanning direction A and B, a platen 13 for supporting a passbook 12 which is fed in a secondary scanning direction C below the print head 11, a leaf spring 14 for applying upper resilient force at both ends of the platen 13 to push the platen 13 toward the print head 11, a gap roller 15 provided on the print head 11, and a ribbon cartridge 17 for supplying an ink ribbon 16 to the print head 11. The running of the print head 11 is guided in the primary scanning direction, and performed with a carriage that is driven. The feeding of the passbook 12 in the secondary scanning direction is performed with feed method with feed rollers.

The gap roller 15 is rolled on a part of the platen 13 and the passbook 12 supported by the platen 13, pressing down the platen 13 and passbook 12, while the print head 11 is driven in the primary scanning direction A and B. While the gap roller 15 is rolled, a print gap that is the space between the top end of the print head 11 and the print face of the passbook 12 is appropriately formed and kept. The ribbon cartridge 17 has a plastic ribbon guide 18 for guiding the ink ribbon 16 to pass near the lower end of the print head 11. The platen 13 is supported at the left and right ends by the leaf spring 14 from the lower side, and guided movably up and down in a groove 19 provided in a frame 20. That is, when the platen 13 is pressed from the upper side by the gap roller 15, it is moved downward D, leaning to the left or right side according to a pressed position.

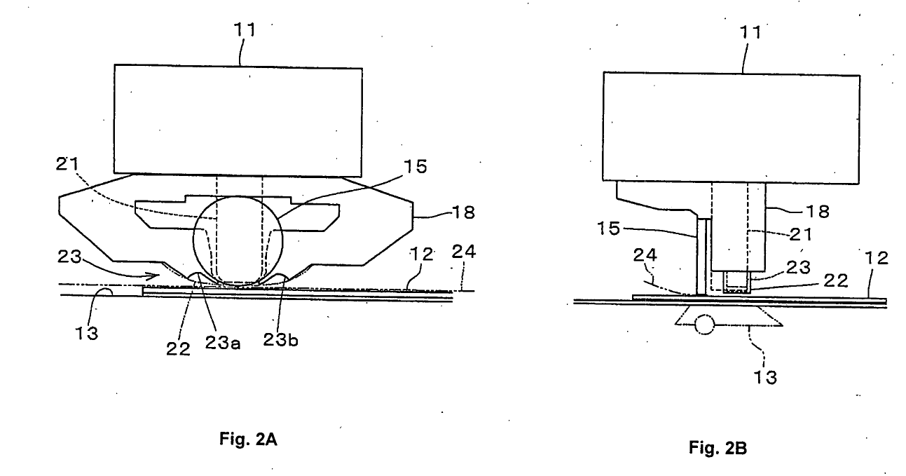

FIGS. 2(a) and 2(b) are a front view and a side view showing the essence of a portion of the print head 11. The print head 11 comprises a nose portion 21 having a guide for a print wire and performs print by protruding the print wire from the tip of the nose portion 21. The ribbon guide 18 has a ribbon shield 22 for preventing the ink of the ink ribbon from sticking to the passbook 12. The ribbon shield 22 is made of a wear resistant sheet having a thickness of 0.13 [mm]. A hole is opened in a portion of the ribbon shield 22 corresponding to a print portion at the tip of the nose portion 21. The print by the print wire is made through this hole. The gap roller 15 is attached in the fore of the ribbon guide 18 in the nose portion 21 of the print head 11.

A lower portion of the ribbon guide 18 constitutes an auxiliary member forming print gap 23 for assisting in forming an appropriate print gap by the gap roller 15. The auxiliary member forming print gap 23 has the contact portions 23a and 23b for expanding a gap between the platen 13 and the print head 11 by contacting via the ribbon shield 22, just before the gap roller 15 contacts to the edge of the passbook 12 during the reciprocal movement of the print head 11 in the primary scanning direction. By this expanding the gap beforehand, the gap roller 15 can contact to the edge of the passbook 12 without forcing the edge of the passbook 12 too downwards and form the appropriate print gap at once. The contact portions 23a and 23b are provided on both sides of the nose portion 21 to cope with the reciprocal movement in the primary scanning direction A and B.

The plastic sheet 24 is provided in a range of the gap roller 15 running on the platen 13. The sheet 24 is raised at an upstream side, as seen in the secondary scanning direction, to feed the passbook 12 beneath it in the secondary scanning direction. The rolling of the gap roller 15 is made on the platen 13 and the passbook 12 with the sheet 24 interposed. That is, the gap roller 15 presses down the passbook 12 and the platen 13 via the sheet 24 to form the appropriate print gap and keep it constant.

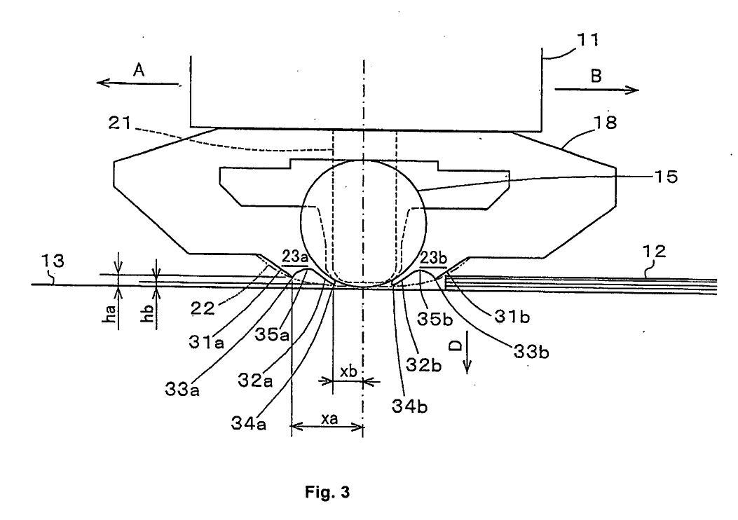

FIG. 3 is a view showing the constitution of the contact portions 23a and 23b. The contact portions 23a and 23b exert force downward D by contacting, just before the gap roller 15 contacts to the edge of the passbook 12 during the reciprocal movement of the print head 11 in the primary scanning direction to assist in forming the print gap with the gap roller 15, as described above. To apply this force, the contact portions 23a and 23b have two contact faces 31a, 32a and 31b, 32b making an acute angle with the print face of the passbook 12 when contacting to the edge of the passbook 12. The contact faces 31a and 31b are located outside the contact faces 32a and 32b to contact the edge of the passbook 12 ahead.

The bottom points 33a and 33b of the contact faces 31a and 31b are at higher positions than the bottom points 34a and 34b of the contact faces 32a and 32b. The bottom points 34a and 34b are at higher positions than the bottom part of the gap roller 15. Between the bottom point 33a and the contact face 32a, and between the bottom point 33b and the contact face 32b, the recesses 35a and 35b are provided to be adaptable to the bulge of a fold part in the center of the passbook 12 when the passbook 12 is the vertical type.

The distance xa from the center of the gap roller 15 to the bottom points 33a and 33b as seen in the primary scanning direction is 9.1 [mm], and the distance ha from the surface of the platen 13 to the bottom points 33a and 33b in the vertical direction is 1.4 [mm]. The distance xb from the center of the gap roller 15 to the bottom points 34a and 34b as seen in the primary scanning direction is 3.9 [mm], and the distance hb from the surface of the platen 13 to the bottom points 34a and 34b in the vertical direction is 0.5 [mm]. The contact faces 31a, 31b, 32a and 32b make an angle of about 30 to 40 degrees with the print face of the passbook 12 to contact smoothly to the edge of the passbook 12 and apply downward force thereto.

With this constitution, when the passbook 12 is printed, the print head 11 prints one line in each of outgoing and return strokes by moving reciprocally within a required range in the primary scanning direction A and B. The line feed is made by movement of the passbook 12 in the secondary scanning direction. Even when the gap roller 15 is running on the passbook 12, the line feed is allowed except during printing, because the sheet 24 (FIG. 2) is interposed. A portion of the passbook 12 being printed by the print head 11 is supported by the platen 13, and the gap roller 15 is moved along with the print head 11 and runs on the passbook 12 and the platen 13 via the sheet 24 (FIG. 2), while pressing down the passbook 12 and the platen 13. Thereby, the distance between the print face and the print head 11 in the print portion under the print head 11, namely, the print gap, is properly formed, and kept.

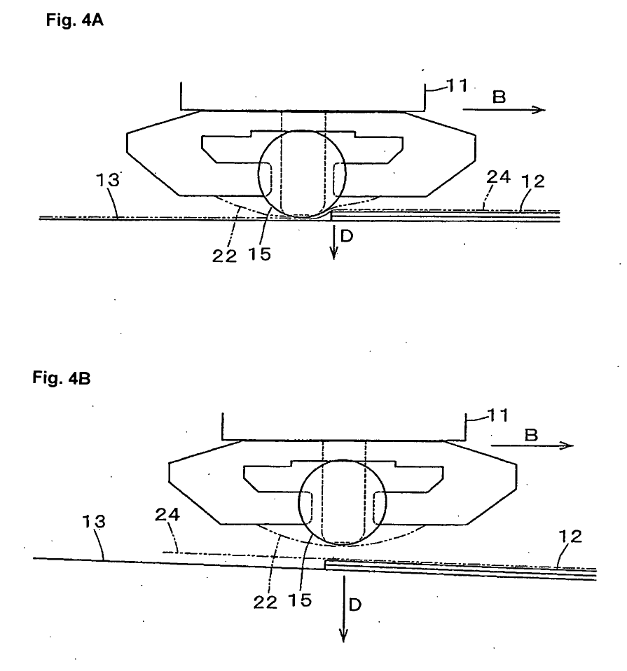

In this case, when the print head 11 passes the edge of the passbook 12, the gap roller 15 contacts the edge and imparts an impact thereon. At this time, when the height of the edge is near the maximum thickness of the passbook 12, for example, about 1.8 [mm], and the running speed of the print head 11 is as fast as 35 inches or higher per second, in the conventional passbook printer, a strong impact is applied on the edge of the passbook 12, so that as the platen 11 is pressed downward D by a considerably strong force, shown in FIG. 4(a). Then, the platen 11 greatly vibrates so that the gap roller 15 is separated from the print face of the passbook 12, as shown in FIG. 4(b). In this state, the print disappears, or become thinner.

On the contrary, with this embodiment, the edge of the passbook 12 first of all contacts via the ribbon shield 22 to the contact face 31b of the contact portion 23b, as shown in FIG. 3. Thereafter, it is pressed down to the level of the bottom point 33b by the contact face 31b. At this time, because the contact face 31b makes an angle of about 30 to 40 degrees with the print face of the passbook 12, the contact with the edge of the passbook 12 is smoothly made. And, because the bottom point 33b of the contact face 31b is 1.4 [mm] higher than the surface of the platen 13, and the thickness of the ribbon shield 22 is 0.13 [mm], the edge of the passbook 12 is pressed down 0.53 (=1.8−1.4+0.13) [mm] by the contact face 31b, when the height of the edge of the passbook 12 is 1.8 [mm].

Then, the edge of the passbook 12 similarly contacts smoothly via the ribbon shield 22 to the contact face 32b and further pressed down to the level of the bottom point 34b by the contact face 32b. At this time, because the height (distance hb) of the bottom point 34b is 0.5 [mm] higher than the surface of the platen 13, and the thickness of the ribbon shield 22 is 0.13 [mm], the edge of the passbook 12 is pressed down 1.43 (=1.8−0.5+0.13) [mm] from the original position before contacting with the contact face 31b.

Thereafter, the edge of the passbook 12 is pressed down residual 0.37 (=1.8−1.43) [mm] by the gap roller 15. At this time, the gap roller 15 contacts with the edge of the passbook 12 without imparting great impact thereon, and forms an appropriate print gap at once without leaving away from the print face of the passbook 12. Accordingly, the print does not disappear or become thinner at the edge of the passbook 12.

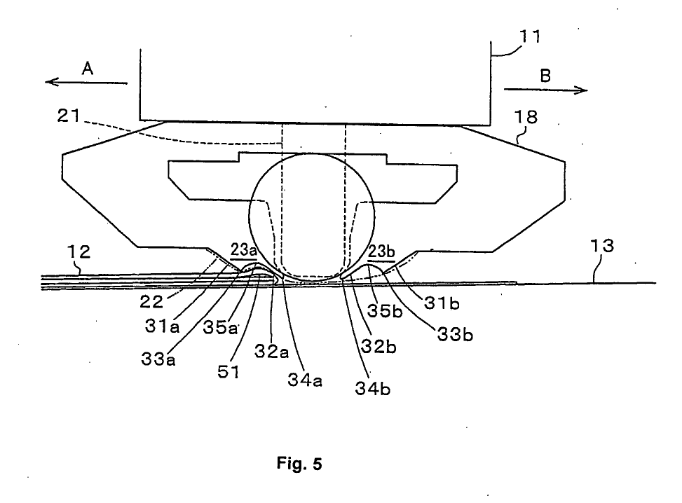

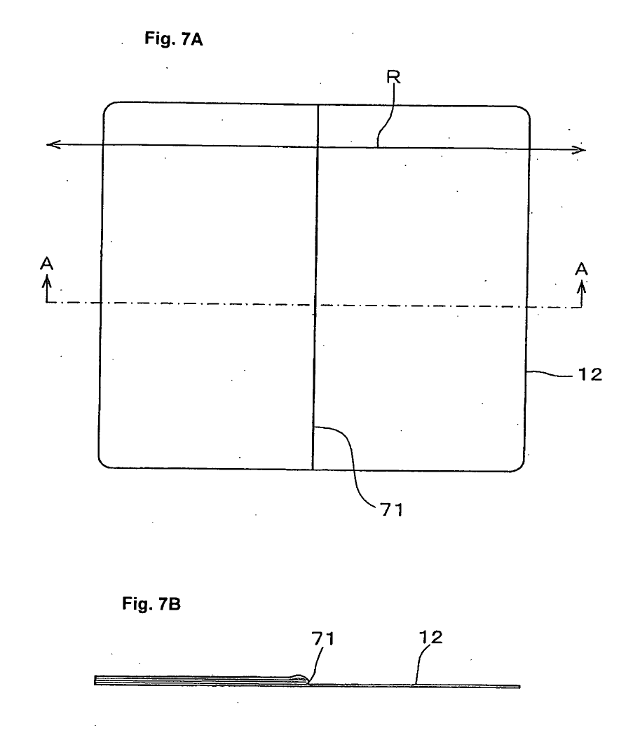

FIG. 5 is a view showing the movement in printing the vertical passbook. FIG. 7(a) is a view showing the open vertical passbook as seen from the above, and FIG. 7(b) is a cross-sectional view of FIG. 7(a) taken along the line A-A. The vertical passbook as shown in FIG. 7 means the passbook 12 which is printed by the print head 11 moving in the direction of the arrow R perpendicular to a central fold 71. At the beginning or end of using the passbook 12, one page is thicker, and the other page is thinner, when a print page is opened, as shown in FIG. 7(b), whereby a great step or bulge is produced in a part of the fold 71. When the left page of the passbook 12 is thicker and the right page is thinner, as shown in FIG. 5, the print head 11 prints the left page by moving in the primary scanning direction B, and when transferring to printing the right page, the gap roller 15 needs to run on a folded part 51 in the center. In this case, when the gap roller 15 reaches the folded part 51, the platen 13 is tilted upwards, and the folded part 51 contains the air and considerably bulges. Accordingly, if the recess 35a is not provided between the bottom point 33a of the contact portion 23a and the contact face 32a and a plane parallel to the print face, the contact portion 23a presses down the bulge of the folded part 51 with a considerable force, when the gap roller 15 runs on the folded part 51. Then, the proper print gap may not be formed, or the proper print pressure not obtained, leading to the risk that the clear print is not made.

However, in this embodiment, since the recess 35a is provided between the bottom point 33a and the contact face 32a, the bulge of the folded part 51 enters the recess 35a and is not pressed, when the gap roller 15 runs on the folded part 51, as shown in FIG. 7. Therefore, immediately after the gap roller 15 runs on the bulge of the folded part 51, the proper print gap is formed on the print face at the right page, enabling the clear print. When the bottom point 33a contacts to the folded part 51, it is near the gap roller 15, with small pressure, whereby the specifications in the print range near the fold are met.

In the above embodiment, since the auxiliary member for forming print gap 23 expands a print gap to a certain extent by contacting, just before the gap roller 15 contacts, to the edge of the passbook 12, and assists in forming the print gap by the gap roller 15, it is possible to avoid poor print quality near the edge of the passbook 12, even when the running speed of the print head 11 is fast and the height of the edge of the passbook 12 is too high. Also, though the ribbon guide 18 is made of plastic, and the contact faces 23a and 23b are made of plastic, the contact with the edge of the passbook 12 is made via the wear resistant ribbon shield 22, whereby there is no risk that the contact portion with the edge of the passbook 12 is worn. Also, because the recesses 35a and 35b are provided, even when one page is higher than the other, and the folded part 51 greatly bulges at the higher page in printing on the vertical passbook, the print is made without poor print quality near the folded part 51.

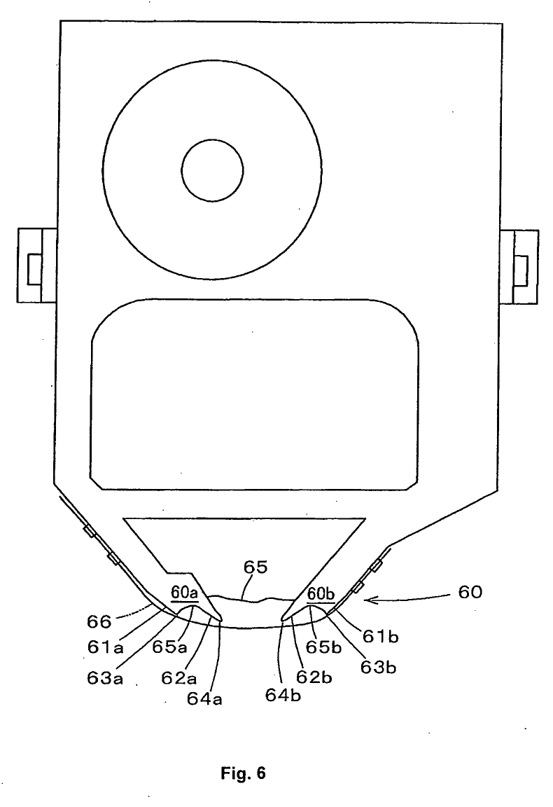

FIG. 6 is a view showing a ribbon cassette according to another embodiment of the invention. A lower portion of this ribbon cassette constitutes the auxiliary member forming print gap 60 to assist in forming appropriate print gap by the gap roller in the printer on which the ribbon cassette is mounted in the same way as above. The auxiliary member forming print gap 60 has two contact portions 60a and 60b. A contact portion 60a has the contact faces 61a and 62a, and a contact portion 60b has the contact faces 61b and 62b. The contact faces 61a, 62a, 61b, 62b and the bottom points 63a, 64a, 63b, 64b have the same constitutions and functions as the contact faces 31a, 32a, 31b, 32b and the bottom points 33a, 34a, 33b, 34b in FIG. 3. In FIG. 6, reference numeral 65 designates an ink ribbon supplied to the lower end of the print head on which the ribbon cassette is mounted. 66 designates a ribbon shield having the same function as the ribbon shield 22 of FIG. 3.

This ribbon cassette is used for the printer of the dot-impact type in which the print gap is formed and kept by in the same way as the printer of FIG. 1. In this case, with the auxiliary member forming print gap 60, it is possible to avoid poor print quality near the folded part in the center of the vertical passbook 12, even when the print head moves at high speed and prints on the thick passbook.

This invention is not limited to the above embodiment, but various variations may be made thereto. For example, each contact portion has two contact faces and bottom points, but may have only one or three or more. Also, the gap roller runs on the passbook with the sheet interposed, but instead may run directly on the print face of the passbook. Also, the gap roller is cylindrical in the above embodiment, but may be spherical if the object of printing permits.

Also, in the above embodiment, the invention is explained by using the dot-impact type printer, but the invention may be applicable to other ink-jet type printer or thermal transfer printer, if it is the serial type printer with the print head moving to the left and right to form appropriate print gap by using gap roller attached to the print head.

In the drawings and specifications there has been set forth a preferred embodiment of the invention and, although specific terms are used, the description thus given uses terminology in a generic and descriptive sense only and not for purposes of limitation.

1) Apparatus comprising:
an auxiliary member forming a print gap disposed at the top end of a print head to assist in forming a predetermined print gap in the printer which comprises the print head for performing print by moving reciprocally in a primary scanning direction to an object of printing which is fed in a secondary scanning direction,
a platen for supporting said object of printing below said print head,
means for applying resilient force to said platen or said print head so that their distance is smaller, and
a gap roller disposed at said print head to form a predetermined print gap by running on the object of printing on said platen against said resilient force along with the movement of said print head,
said auxiliary member comprising:
a contact portion for expanding the gap between said platen and said print head by contacting just before said gap roller contacts to the edge of the object of printing during the reciprocal movement of said print head.

2) Apparatus according to claim 1, wherein said contact portion has a contact face contacting just before said gap roller contacts to the edge of said object of printing at an acute angle with a print face to cause the force expanding said gap, a bottom point of said contact face being higher than a lower end of said gap roller.

3) Apparatus according to claim 2, wherein said contact portion has a first contact face and a second contact face, said first contact face contacts to the edge of said object of printing before said second contact face, with the bottom point being higher.

4) Apparatus according to claim 3, wherein a recess adaptable to a bulge in a central folding part is provided between the bottom point of said first contact face and said second contact face, when the object of printing is a vertical passbook.

5) Apparatus according to claim 3, wherein said two contact faces are provided to correspond to the reciprocal movement of said print head.

6) Apparatus according to claim 1, wherein when said print head is dot-impact type, and said contact portion contacts to the edge of said object of printing via a ribbon shield.

7) A ribbon guide having the auxiliary member forming print gap according to claim 1, which is provided inside said ribbon shield.

8) A ribbon cartridge having the ribbon guide according to claim 7.

9) A ribbon cassette having the auxiliary member forming print gap according to claim 1, which is provided inside said ribbon shield.

10) A printer comprising:
a print head for performing print by moving reciprocally in a primary scanning direction to an object of printing, said object of printing being fed in a secondary scanning direction;
a platen supporting said object of printing below said print head;
means for applying resilient force to said platen and said print head so that their distance is smaller;
a gap roller forming a predetermined print gap by running on said object of printing on said platen against said resilient force along with the movement of said print head, said gap roller provided in said print head; and
the auxiliary member forming a print gap according to claim 1.

11) A method for printing comprising the steps of:
printing by a print head by moving a print head along a platen in a primary scanning direction, against an object of printing fed in a secondary scanning direction on said platen;
applying resilient force in a direction such that the distance between said platen and print head becomes closer;
forming a predetermined print gap by a gap roller set on said print head, said forming being performed by running on said object of printing on said platen against said resilient force during a reciprocal movement of said print head; and
expanding a gap between platen and print head just before said gap roller contacts to an edge of said object of printing during said reciprocal movement of said print head by contact portions of said auxiliary member set on the top of said print head, said auxiliary member being any of claim 1.
